(19) United States
(12) Patent Application Publication
(10) Pub. No.: US 2026/0312864 A1
(43) Pub. Date: Oct. 8, 2026

(54) DYNAMIC ANOMALY DETECTION AND RESPONSE TO PROVISIONING ERRORS FOR TELECOMMUNICATIONS NETWORKS

(71) Applicant: T-Mobile USA, Inc., Bellevue, WA (US)

(72) Inventors: Henry P. Cyril, Bothell, WA (US); Neal Murphy, Bucyrus, KS (US); Madana Saney, Overland Park, KS (US); Shrustishree Sumanth, Bothell, WA (US)

(21) Appl. No.: 19/171,026

(22) Filed: Apr. 4, 2025

(51) Int. Cl. H04L 41/0806; H04L 41/0604; H04L 41/0654; H04L 43/04

(52) U.S. Cl. CPC H04L 41/0806; H04L 41/0609; H04L 41/0654; H04L 43/04

(57) ABSTRACT

The disclosed technology manages the detection and response to anomalies in network provisioning within wireless telecommunications networks. The technology is configured to receive and segment network provisioning data from multiple service providers based on service requests and provisioning statuses. An anomaly detection model processes the segmented data to identify deviations from expected provisioning patterns and detects provisioning failures and systemic issues. Upon detecting anomalies, alerts are generated to indicate the type, severity, and affected network elements. Corrective actions are then triggered, which can involve adjusting network parameters, rerouting requests, or deploying software patches via an integration/continuous deployment (CI/CD) pipeline. The anomaly detection model is continuously updated through a feedback loop, integrating real-time data and past corrective actions to refine future detection accuracy. This iterative learning process can improve network reliability and efficient provisioning operations.

### BACKGROUND

Telecommunications networks rely on network provisioning to configure and manage services for subscribers across multiple service providers. Network provisioning refers to the process of allocating and configuring network resources to enable services such as voice calls, messaging, voicemail, and mobile data. Network provisioning ensures that a subscriber's selected plan is properly established within the network infrastructure, allowing seamless service activation and connectivity. The operations for network provisioning involve multiple interconnected steps, including resource allocation (e.g., bandwidth, IP addresses, routing paths) and service configuration, where network elements such as subscriber databases, authentication servers, and policy control functions are programmed with the appropriate parameters to enable subscriber-specific services.

Subscriber authentication and authorization are processes performed by the network elements in network provisioning. The processes verify a user's identity and grants access based on their service plan and entitlements. The processes allow subscribers to receive the correct services while maintaining network security. In addition to authentication and authorization, network provisioning requires the coordination of multiple network elements, such as switches, routers, policy control functions, subscriber databases, and messaging gateways, to maintain service continuity across different network layers. The complexity of modern telecommunications networks, particularly those supporting multiple service providers and millions of users, makes network provisioning an intricate and resource-intensive process. Errors in network provisioning can lead to service disruptions, delayed activations, or degraded network performance, requiring efficient mechanisms for error detection, system monitoring, and network optimization. As networks continue to expand and incorporate new technologies, efficient network provisioning remains of importance to providing reliability to telecommunications infrastructure.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 illustrates the architecture of a system that can enable service activation, suspension, and modification for subscribers across multiple brands and service providers within a wireless telecommunications network.

FIG. 3 illustrates the architecture of a system with a set of network elements classified into core network elements and non-core network elements.

FIG. 4 illustrates a scenario in which a system encounters a provisioning failure while processing a service request.

FIG. 5 illustrates an error code analysis and prediction system that can process provisioning error events from the network provisioning engine to detect, analyze, and forecast provisioning failures.

FIG. 6 illustrates a system that can segment network provisioning data before processing service requests.

FIG. 7 illustrates the architectural framework of a system, providing a detailed view of the process methods described herein.

FIG. 8 is a flowchart of a process performed by a network provisioning system for detecting and responding to anomalies in network provisioning for a wireless telecommunications network.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system and method for detecting and responding to anomalies in network provisioning within a wireless telecommunications network. In particular, the technology can identify provisioning failures, systemic network issues, and deviations from expected provisioning patterns across multiple service providers (e.g., METRO, Postpaid, Prepaid, Wholesale). By leveraging an anomaly detection model trained on historical provisioning data, the technology can improve network reliability and can ensure that provisioning operations continue without service degradation. The technology can further provide automated corrective actions, such as rerouting provisioning requests, adjusting network provisioning parameters, or deploying software patches via a continuous integration/continuous deployment (CI/CD) pipeline, to mitigate network provisioning failures.

The technology (e.g., referred to as network provisioning system) can receive and process network provisioning data, including service requests (e.g., activate subscriber voicemail, change plan, identify service provider, time parameter associated with service request) and provisioning status (e.g., transaction per second values, error code) from a plurality of service providers. The provisioning status comprises indicators of successful and failed provisioning attempts.

The network provisioning system can segment the received network provisioning data per service provider and based on at least one of the service requests and/or provisioning status. For example, segmentation can categorize network provisioning data based on a service provider identifier, a time parameter (e.g., timestamps for provisioning requests), transaction per second values, associated error codes, or affected network elements. By segmenting the data before processing, the network provisioning system can improve the accuracy of the anomaly detection model by allowing the anomaly detection model to detect trends and deviations within specific service providers, network elements, or provisioning categories. The segmentation process can ensure that provisioning patterns are analyzed in a structured manner, allowing the anomaly detection model to differentiate between localized provisioning failures and systemic anomalies affecting multiple service providers.

The network provisioning system can process the segmented network provisioning data using an anomaly detection model that identifies deviations from expected provisioning patterns, such as statistical spikes in transaction per second values, increased failure rates, or unexpected error codes appearing across multiple provisioning clusters. The anomaly detection model can continuously learn from historical provisioning data to establish a baseline of normal provisioning behavior (e.g., expected provisioning patterns), allowing the anomaly detection model to detect provisioning failures that exceed normal operating thresholds.

To address provisioning failures, the network provisioning system can determine when an anomaly in network provisioning reaches a threshold that requires intervention. The threshold can be based on factors such as sudden increases in failed provisioning attempts, deviations from expected provisioning success rates, or systemic failures affecting multiple service providers simultaneously. Upon detecting an anomaly, the network provisioning system can generate an alert that is prioritized based on a severity assessment, ensuring that high-severity anomalies affecting multiple service providers are addressed before lower-severity issues. The alert can identify the affected network elements and service providers. The alert can be transmitted to a network operations team for corrective action.

Once an anomaly is detected and classified, the technology triggers an automated corrective action to mitigate the impact on network provisioning. In cases where a specific provisioning cluster fails or experiences excessive failures, the network provisioning system can reroute provisioning requests to an alternative provisioning cluster in a different data center to maintain service continuity. Additionally, network provisioning parameters can be adjusted in response to an anomaly to ensure successful service activations, modifications, or terminations. The corrective action can also include deploying a software patch via a CI/CD pipeline to resolve persistent provisioning failures caused by system misconfigurations or software defects.

The disclosed technology can ensure that provisioning operations continue efficiently by continuously refining the anomaly detection model through a feedback loop. Real-time feedback from corrective actions taken in response to provisioning failures is integrated into the model, enabling it to improve its accuracy in detecting and predicting future anomalies. This iterative learning process can allow the anomaly detection model to identify systemic issues more effectively over time and adapt to new types of provisioning failures that can arise due to network updates, service provider changes, or evolving network conditions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

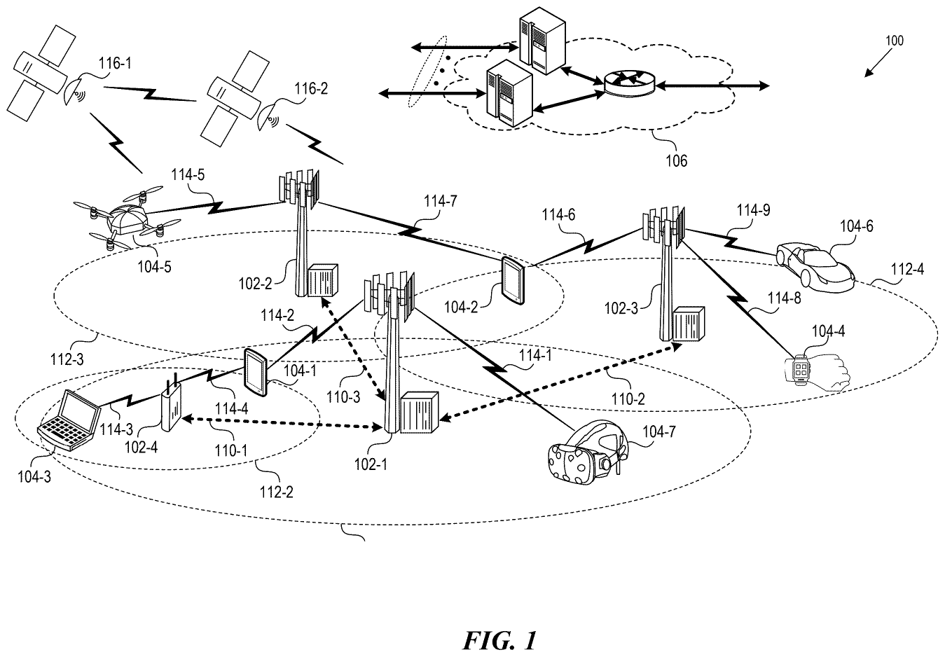

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Network Provisioning System

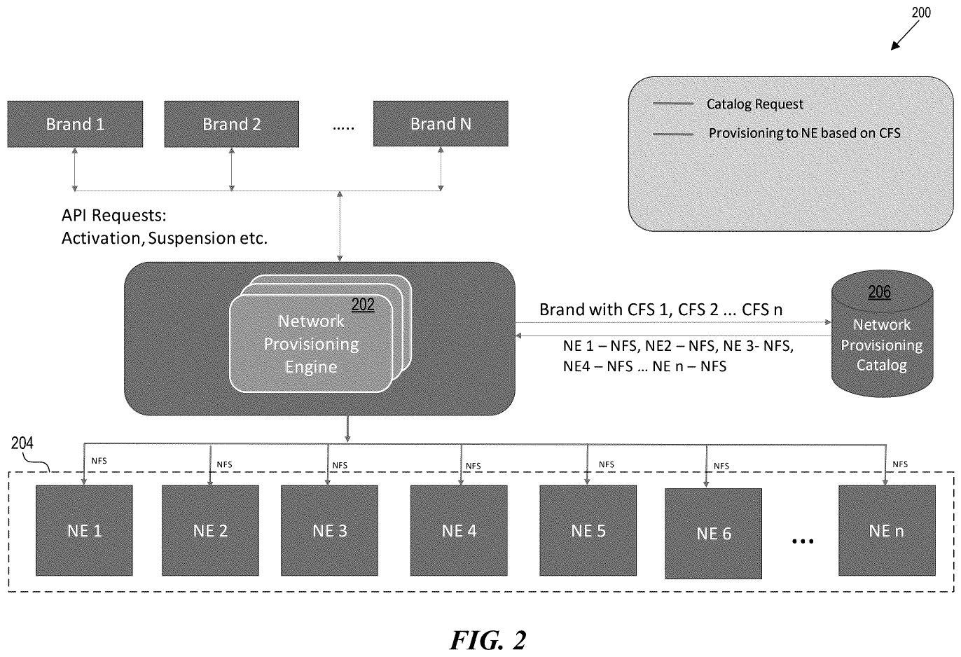

FIG. 2 illustrates the architecture of a network provisioning system 200 that can enable service activation, suspension, and modification for subscribers across multiple brands and service providers within a wireless telecommunications network. Network provisioning engine 202 can translate and execute provisioning requests across different network elements 204.

When a customer initiates a service request (e.g., activating a new mobile line, subscribing to an international calling plan, or modifying an existing plan), the request originates from a front-end system associated with a specific service provider or brand (e.g., Metro, Postpaid, Prepaid, Wholesale). These brands (e.g., Brand 1, Brand 2, and Brand N) represent different types of customer offerings managed by the telecommunications provider. The network provisioning system 200 can generate an API request containing details about the customer's selected services and transmits the request to the network provisioning engine 202.

The network provisioning engine 202 can process these API-based service requests and convert the API requests (e.g., service activation, suspension, modification) into network-facing service (NFS) commands that are understandable by the core network infrastructure. Since the wireless telecommunications network does not directly interpret customer-facing service (CFS) terminology (e.g., premium unlimited data plan, international calling add-on), the network provisioning engine 202 can use a network provisioning catalog 206 to translate CFS requests into NFS configurations. This translation ensures that provisioning commands are properly structured and executed within the wireless telecommunications network.

Once the network provisioning engine 202 determines the required NFS configurations, the network provisioning engine 202 can distribute the provisioning commands to the network elements 204 responsible for enabling the requested services. The network provision engine 202 provisions service parameters to network elements 204 such as NE 1, NE 2, NE 3, NE 4, NE 5, NE 6, and additional network components as needed. Each network element in the networks elements 204 is responsible for a specific service function.

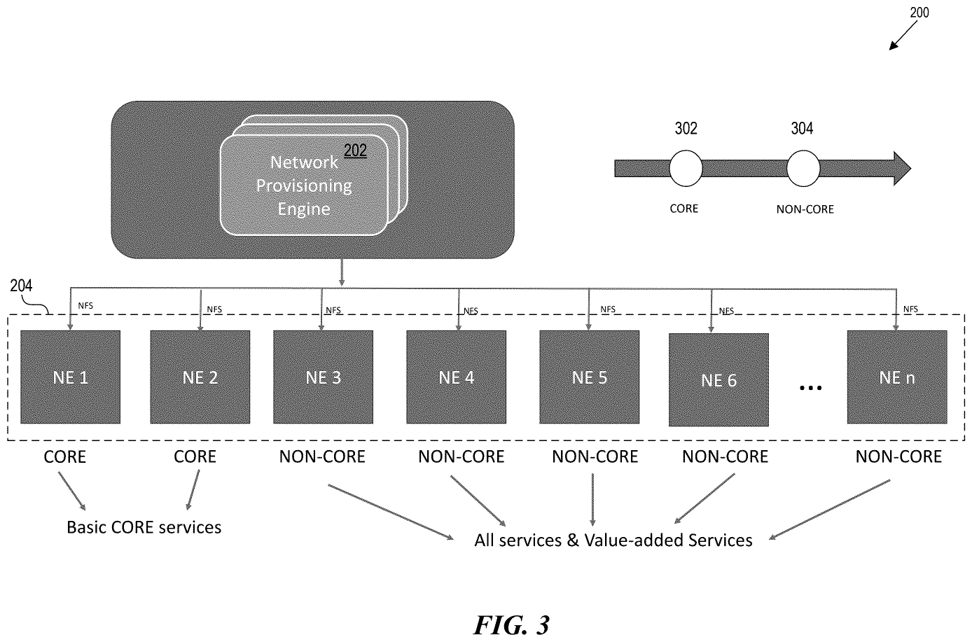

FIG. 3 illustrates the architecture of the network provisioning system 200 with a set of network elements 204 classified into core network elements 302 and non-core network elements 304. The network provisioning engine 202 provisions services across core network elements 302 to enable basic core services and across non-core network elements 304 to provide value-added services (e.g., enhance the functionalities of the wireless telecommunications network services).

Core network elements 302 (e.g., fundamental infrastructure components) can enable basic connectivity and wireless telecommunications network services. Provisioning the core network elements 302 can establish a data session, send SMS messages, and make voice calls for a subscriber. These network elements 204 can include subscriber authentication servers, mobility management entities, and basic routing functions that facilitate minimal network access even if additional services are unavailable. While provisioning core network elements 302 can provide basic core services, the core network elements 302 cannot provide all services that can improve the wireless telecommunications network quality or user experience.

Non-core network elements 304 provides value-added services (e.g., premium communication features) that can improve network performance and user experience. The non-core network elements 304 can include components that enable voicemail services, identity and access management, rich communication services (RCS), peer-to-peer messaging, and machine-to-peer messaging. Unlike core network elements 302, the non-core network elements 304 are not mandatory for basic service functionality. However, the non-core network elements 304 provisioning can improve the capabilities of the wireless telecommunications network, allowing for advanced messaging features, optimized data transmission, and improved service quality.

The classification of network elements 204 into core network elements 302 and non-core network elements 304 can allow the network provisioning engine 202 to prioritize service activation based on the subscriber's selected plan. For example, a basic service plan may only require core network elements 302 to be provisioned to allow basic connectivity services. Conversely, a premium service plan may involve provisioning both core network elements 302 and non-core network elements 304 to allow access to advanced communication features, cloud-based storage, and multimedia messaging services.

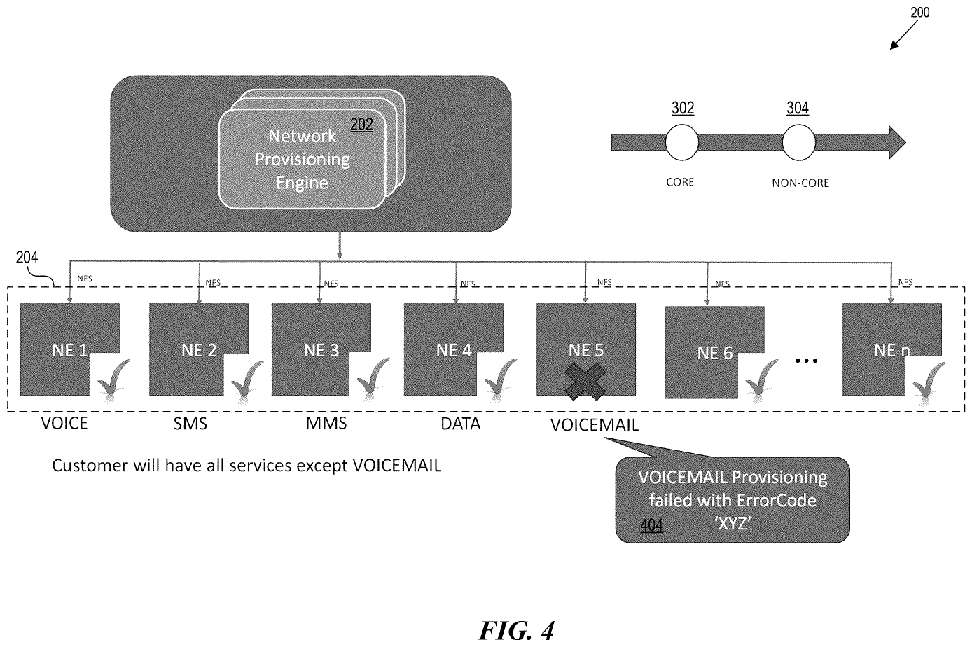

FIG. 4 illustrates a scenario in which the network provisioning system 200 encounters a provisioning failure while processing a service request. The network provisioning engine 202 transmits provisioning commands to the network elements 204 based on the subscriber's service plan and entitlements. The scenario highlights how provisioning is successful for network elements associated with voice, SMS, MMS, and data services (e.g., network elements NE 1 to NE 4). However, provisioning failures can occur due to various issues such as system outages, misconfigurations, resource limitations, or software defects. When a failure occurs, the network provisioning engine 202 can detect the issue and log an error code. Error codes can serve as an identifier for failure analysis, troubleshooting, and corrective actions. Each error code can indicate the affected service (e.g., voice, messaging, data), the specific network element that experienced the failure (e.g., NE 1 or NE n), and the underlying cause of the failure, such as network congestion, misconfigured service parameters, or system outages.

For example, provisioning fails for voicemail services at network element NE 5 from network elements 204, resulting in an error code 404. Error code 404 can indicate that voicemail provisioning at network element NE 5 was unsuccessful. Error code 404 can serve as a trigger for initiating corrective actions within the network provisioning system 200. The network provisioning engine 202 can attempt voicemail provisioning at NE 5 by redirecting the voicemail provisioning request to an alternative network element (e.g., NE 6) from the network elements 204 if the alternative network element is available to take over the provisioning function (e.g., voicemail) if the primary network element fails. Furthermore, the network provisioning system 200 can incorporate machine learning-based anomaly detection models to analyze error code trends and predict potential provisioning failures before the provisioning failures impact the service quality for wireless telecommunications network.

In one embodiment the network provisioning engine 202 can attempt voicemail provisioning at NE 5 after a predefined interval indicates the error 404 persists. For example, if NE 5 fails due to temporary congestion, the network provisioning system 200 can retry provisioning after 30 seconds to verify if the error 404 can be resolved over the predefined interval before escalating to redirecting the provisioning request to an alternative network element or generate an alert for manual intervention by network operations teams.

By classifying and prioritizing error codes, the network provisioning engine 202 can determine whether a provisioning failure affects an individual subscriber, a group of users, or an entire service category. Configuring the network provisioning engine 202 to classify and prioritize error codes can ensure that critical failures are promptly addressed while lower-priority error codes are handled accordingly (e.g., scheduled for maintenance).

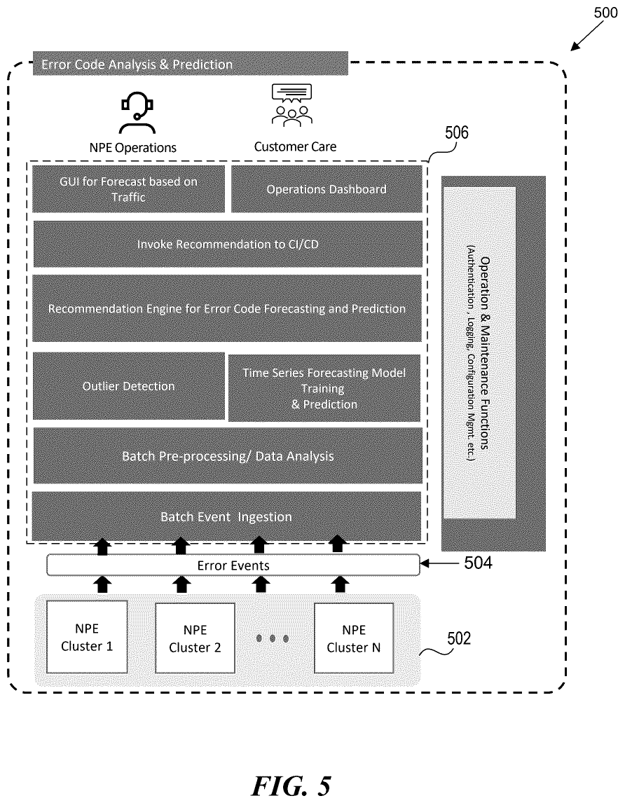

FIG. 5 illustrates an error code analysis and prediction system (e.g., referred to as “ECAP 500”) that can process provisioning error events from the network provisioning engine 202 to detect, analyze, and forecast provisioning failures. The ECAP 500 includes components that can be configured for various processes (e.g., batch event ingestion, outlier detection, CI/CD) involved in error code analysis, anomaly detection, forecasting, and recommendation generation of corrective actions via a processing pipeline 506.

ECAP 500 can receive provisioning error data from multiple network provisioning engine clusters 502, where each cluster corresponds to a specific service provider (e.g., Metro, Postpaid, Prepaid, Wholesale). The error events 504 can represent provisioning failures and contain all the provisioning error data (e.g., error codes, failed activation logs, affected network elements) reported by the network provisioning engine clusters 502. The error events 504 are then transferred to the processing pipeline 506 for ECAP 500 to prepare the provisioning error data for further analysis.

In some embodiments, the processing pipeline 506 for ECAP 500 can include of the following components: (1) batch event ingestion, (2) batch pre-processing and data analysis, (3) outlier detection, (4) time series forecasting model training and prediction, (5) recommendation engine for error code forecasting and prediction, (6) invoke recommendation to CI/CD, and (7) GUI for forecast-based traffic monitoring and operations dashboard.

The batch event ingestion component of the processing pipeline 506 can collect and aggregate provisioning error data from error events 504. Batch event ingestion can capture and structure raw provisioning error data for further processing. The batch event ingestion process can be configured to handle high-volume data streams from multiple network provisioning engine clusters 502, allowing for real-time and batch processing of provisioning failures. Once the provisioning error data is ingested, the ingested provisioning error data is made available for pre-processing, data analysis, and anomaly detection.

After the provisioning error data is ingested, the batch pre-processing and data analysis component can structure and organize the ingested provisioning error data to maintain consistency and accuracy to ensure that provisioning failures are correctly categorized and analyzed for effective anomaly detection and predictive modeling. Batch pre-processing can involve filtering and validating the ingested provisioning error data by removing incomplete, duplicate, or corrupted error logs to ensure that only valid data is processed. Additionally, the provisional error data is configured into a structure that can allow for integration into one or more analytical models. As part of batch pre-processing process, an initial trend analysis can be performed to identify frequently occurring errors, service-specific failures, or systemic issues affecting specific network elements 204. The pre-processed data can now continue through the provisioning pipeline 506 into subsequent outlier (e.g., anomaly) detection and forecasting models to improve accurate provisioning failure prediction and effective corrective action recommendations for the network provisioning system 200 to perform.

The outlier detection component can apply machine learning-based anomaly detection algorithms (e.g., anomaly detection model) to identify statistical deviations from expected provisioning patterns. By analyzing historical provisioning data, the outlier detection component can compare current error trends to detect anomalies that can indicate systemic issues rather than provisioning failures that occur under normal operating conditions. Outlier detection can differentiate expected provisioning failures (e.g., temporary network congestion, failures that resolve automatically on retry) that occur under normal operating conditions from anomalies that indicate persistent failures, such as provisioning spikes, repeated failures, or unusual error patterns that may signal network-wide issues affecting multiple service providers. By identifying these anomalies, the ECAP 500 can prioritize failures that require intervention while filtering out routine errors, thereby improving the efficiency of error analysis and corrective action processes.

The time series forecasting model training and prediction component can analyze historical provisioning failures to anticipate potential future failures. By employing machine learning algorithms (e.g., ARIMA or neural forecasting models), ECAP 500 can identify patterns in provisioning errors and forecast high-risk periods when failures are more likely to occur. The high-risk periods can include peak activation hours or large-scale events (e.g., Black Friday), in which provisioning requests can surge beyond normal thresholds. Additionally, time series forecasting can allow the ECAP 500 to detect long-term trends in provisioning errors across multiple service providers, which can allow network teams to implement proactive mitigation strategies. By providing early warnings for potential service degradation before failures occur, ECAP 500 can improve network stability and reduce the likelihood of widespread provisioning failures for subscribers using the wireless telecommunications network.

The recommendation engine for error code forecasting and prediction component can generate automated corrective actions based on detected anomalies and forecasted trends. By evaluating the refined provisioning error data (e.g. data that has been ingested, pre-processed, analyzed, and used to train models), the recommendation engine can determine the best course of action to mitigate service disruptions. The corrective actions can include retrying failed provisioning attempts based on predefined logic, redirecting provisioning requests to alternative network elements when redundancy is available, or generating priority-based alerts for manual intervention by network operations teams. By automating the decision-making process for corrective actions, the recommendation engine can provide proactive resolution of provisioning failures, reducing the need for reactive troubleshooting and improving overall wireless telecommunications network reliability.

The invoke recommendation to CI/CD component can integrate automated corrective actions into the CI/CD pipeline. The CI/CD pipeline can enable network provisioning system 200 updates, network patches, and service optimizations to be deployed without manual intervention. Through this process, the ECAP 500 can automatically push corrective actions to resolve persistent provisioning errors, deploy software patches to correct network misconfigurations, and continuously update the network provisioning engine 202 based on real-time error trends. By integrating corrective actions into CI/CD, ECAP 500 can minimize the need for manual troubleshooting and can ensure that provisioning errors are dynamically resolved.

The final component in the processing pipeline 506 for ECAP 500 can involve presenting the processed error code analysis and prediction data to network engineers and customer support teams through an interactive GUI and operations dashboard. The GUI for forecast-based traffic monitoring can allow engineers to visualize error trends, provisioning spikes, and service degradation risks in real time, providing insights into potential network failures before the failures occur. The operations dashboard can serve as a centralized interface for monitoring error classification, prioritizing anomalies, and reviewing corrective actions, enabling teams to track provisioning failures and assess system performance efficiently. By providing real-time analytics and actionable insights, the tools (e.g., GUI or operations dashboard) can help network teams make informed decisions about error mitigation and service optimization.

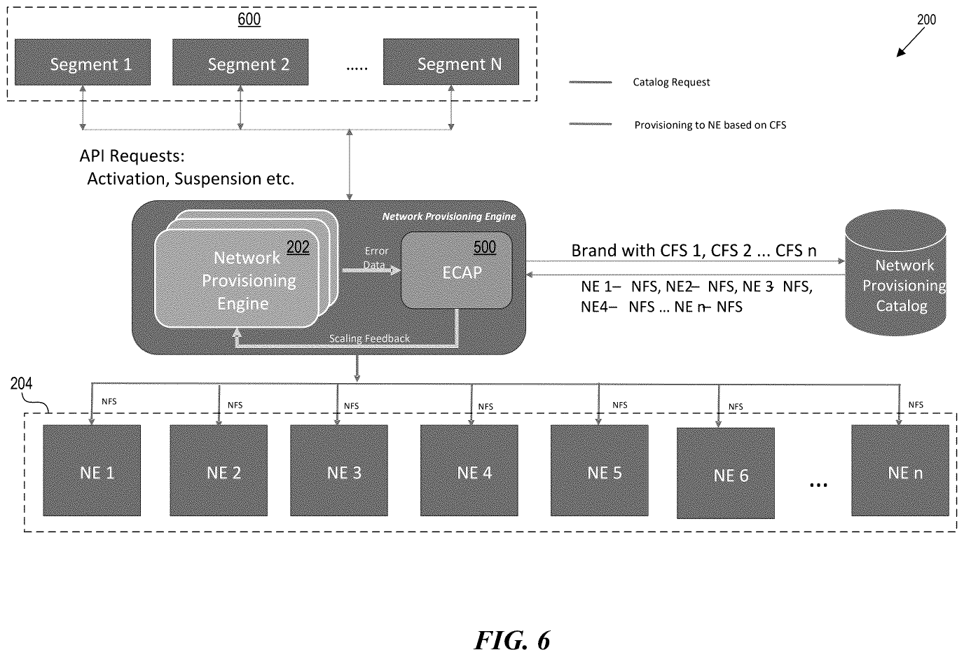

FIG. 6 illustrates a network provisioning system 200 that can segment network provisioning data as segments 600 before processing service requests. The segmentation process can categorize network provisioning data per service provider (e.g., Metro, Postpaid, Prepaid, Wholesale). Segmentation can further group the network provisioning data based on specific service requests (e.g., activation, modification, suspension) and/or the provisioning status (e.g., successful provisioning, failed provisioning with associated error codes). Segments 600 (e.g., the segmented data by network provisioning system 200) is then transmitted to the network provisioning engine 202 to process the segmented network provisioning data to execute provisioning commands across network elements 204. If provisioning failures occur, the network provisioning engine 202 can extract and transmit network provisioning error data to the ECAP 500. ECAP 500 can analyze the error data, apply machine learning-based anomaly detection, forecast potential provisioning failures, and generate corrective actions. ECAP 500 can provide scaling feedback to network provisioning engine 202, allowing dynamic provisioning adjustments (e.g., automatic corrective actions based on recommendations from trained forecast models). By providing segments 600 to the network provisioning engine 202 and integrating the network provisioning engine 202 with ECAP 500, the network provisioning system 200 can improve provisioning accuracy, service availability, and automate corrective actions for provisioning failure.

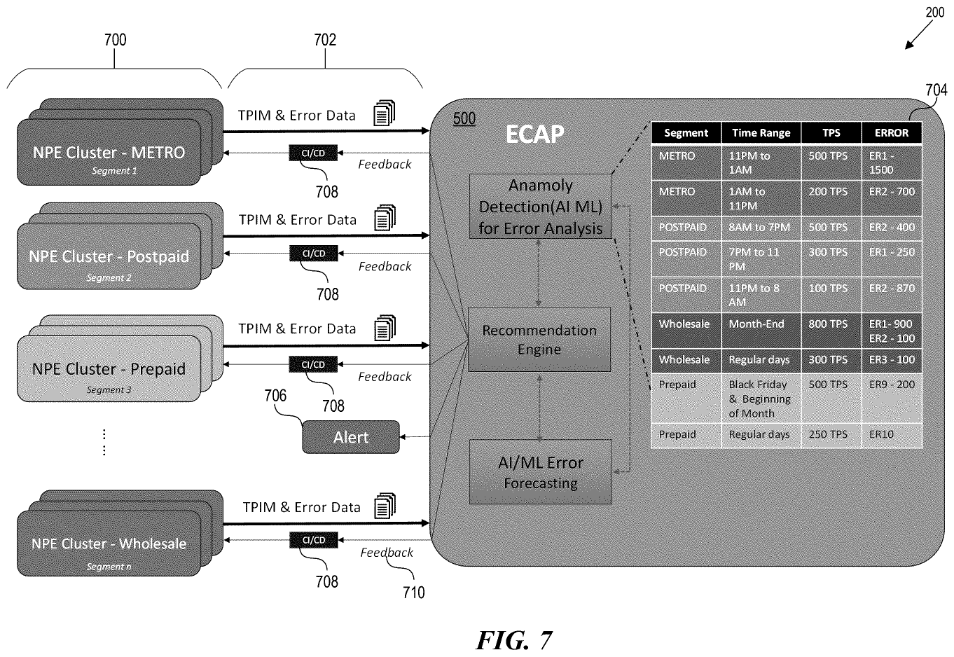

FIG. 7 illustrates the architectural framework of network provisioning system 200, providing a detailed view of the process methods occurring between ECAP 500 and the clusters 700 that originate from the network provisioning engine 202 (refer to FIG. 6). Clusters 700 are multiple clusters generated by the network provisioning engine 202 (e.g., processes provisioning requests, executes service activations or modifications, and identifies provisioning failures). Clusters 700 are the segmented network provisioning data processed by the network provisioning engine 202, where each cluster that has been segmented can correspond to a distinct service provider (e.g., Metro, Postpaid, Prepaid, or Wholesale). Each cluster 700 can contain network provisioning error data, such as transaction per second (TPS) metrics, failed service activations, and other provisioning-related issues. The error data 702 (e.g., segmented error data from multiple clusters, TPIM & Error Data) can be transmitted to ECAP 500 for further processing, advanced analysis, to train anomaly detection models, and predictive modeling.

ECAP 500 can function as the processing unit for detecting, analyzing, and forecasting provisioning failures. Within ECAP 500, the anomaly detection (AI/ML) module (e.g., anomaly detection model) can evaluate incoming error data 702 from clusters 700 and compare observed error trends against historical patterns. Analyzing the error data 702 can determine whether a provisioning failure is part of an expected provisioning fluctuation or if the error data 702 represents a systemic issue requiring immediate intervention (e.g., automatic corrective action, manual intervention). The error data 702 can be organized as the data structure 704 that can contain parameters such as segment (e.g., segmented data per service providers), time range, transaction per second (TPS) values, and error codes. By aggregating and analyzing these metrics, ECAP 500 can distinguish between common provisioning failures and significant anomalies that indicate potential network-wide issues.

ECAP 500 can generate an alert 706 that indicates the type and severity of the anomaly and identifies affected service providers and network elements responsible for the provisioning failure. When one or more anomalies are detected, the alert 706 can trigger a recommendation engine (e.g., process within ECAP 500) to determine the most effective corrective actions based on historical error patterns and real-time system conditions provided by the data structure 704. The recommendation engine can suggest corrective actions such as reattempting failed provisioning requests, rerouting provisioning tasks to alternate network elements, or adjusting provisioning parameters to reduce failure rates. The alert 706 can notify network operations teams for manual intervention if the provisioning failure persists beyond the network provisioning system's automated resolution capabilities.

In parallel, ECAP 500 can employ AI/ML Error Forecasting to anticipate future provisioning failures by analyzing historical trends and real-time transaction volumes. The predictive analysis can enable the network provisioning system 200 to proactively mitigate failures before the provisioning errors impact customers. By forecasting provisioning errors, ECAP 500 can provide the network provisioning system 200 predictions (e.g., potential errors that can occur on a given time range based on historical error trends) that can automatically allocate resources efficiently and prevent widespread service disruptions in the wireless telecommunications network. In another embodiment, forecasting provisioning errors with the ECAP 500 can provide network operation teams (e.g., engineers) predictions that can recommend manual intervention to allocate resources efficiently and prevent widespread service disruptions in the wireless telecommunications network.

Once ECAP 500 can identify one or more corrective actions, the network provisioning system 200 can transmit the corrective action recommendations via the CI/CD pipeline 708. The CI/CD pipeline 708 transmits the corrective action recommendations to the network provisioning engine 202, which can enable automated corrective actions that fix provisioning failures occurring in network elements. The clusters from clusters 700 continuously transmit updated provisioning error data to ECAP 500, which can allow continuous monitoring and refinement of corrective actions and provisioning error mitigation strategies. The CI/CD pipeline 708 and the error data 702 can form a feedback loop 710. The feedback loop 710 can allow the network provisioning system 200 to address the provisioning failures dynamically, allowing for real-time adaptation to network conditions while reducing the need for manual troubleshooting. Continuous updates from the feedback loop 710 can provide automatic software patches, configuration changes, or adjustments to network provisioning policies.

For example, a network provisioning system is responsible for activating voicemail services for subscribers across multiple service providers, such as METRO, Postpaid, Prepaid, and Wholesale, in a wireless telecommunications network. Under normal operating conditions, voicemail provisioning is processed across multiple network elements, with each network element handling different service types, including voice, SMS, MMS, data, and voicemail. A new subscriber initiates a voicemail activation request, which the network provisioning system routes to a designated network element responsible for voicemail provisioning. However, during a high-demand period, such as a Black Friday promotional event, the network provisioning system experiences an abnormal increase in transaction per second (TPS) values, particularly affecting prepaid customers. The TPS spikes from a typical 250 TPS to 500 TPS during the peak period. Due to the TPS surge in provisioning requests, the designated network element responsible for voicemail provisioning fails to process voicemail activation requests, returning an error code in response to multiple failed provisioning attempts.

As a result of the voicemail provisioning failure, customers successfully receive other services such as voice, SMS, MMS, and data but are unable to access voicemail services, leading to customer complaints and potential service degradation. The anomaly detection model processes the segmented network provisioning data and identifies a statistical deviation from expected provisioning patterns. The anomaly detection model detects a sudden increase in TPS values for prepaid customers during the Black Friday promotional period. Additionally, the anomaly detection model establishes a correlation between high TPS values and voicemail provisioning failures and recognizes a consistent occurrence of the error code across multiple failed voicemail activation requests.

Upon detecting the anomaly, the network provisioning system generates an alert, prioritizing the alert based on a severity assessment since the failure affects voicemail services across multiple customers. In one embodiment, the alert is transmitted to the network operations team for corrective action to restore voicemail provisioning. In another embodiment, to mitigate service disruption, the network provisioning system triggers an automated corrective action by rerouting voicemail provisioning requests from the failing network element to an alternative network element in a different data center that has available processing capacity. Additionally, the network provisioning system adjusts network provisioning parameters to reduce the number of request retries on the failing network element and distribute the provisioning load dynamically across other available elements. If the anomaly persists, the network provisioning system can also deploy a CI/CD software patch to resolve potential misconfigurations affecting voicemail activation workflows.

By detecting the voicemail provisioning failure and executing corrective actions, the network provisioning system prevents widespread voicemail activation failures while ensuring continuous service availability for customers. Furthermore, real-time feedback from the corrective actions is integrated into the anomaly detection model, improving the anomaly detection model's ability to predict and prevent future voicemail provisioning failures during peak traffic events.

An error analysis interface within the network provisioning system 200 can provide insights into transaction failures and network provisioning errors. The error analysis interface can include one or more data visualization interfaces that display provisioning failure trends and the distribution of errors across network elements. For example, an error analysis interface can provide a structured visual depicting the transactions error counts and the reasoning for the transaction errors, while another error analysis interface can provide a structured visual depicting the error count per each network element.

In one embodiment, each row in the error analysis interface can detail an error code, the affected network element, a brief error description, and the frequency of provisioning failure occurrence. The data can be categorized by error type, service provider segment, element, cluster, and environment. The categorization can allow the network provisioning system 200 and/or engineers to assess error distribution and identify recurring failures. Common provisioning errors can include transaction authorization failures, missing subscriber information, or system validation errors, all of which can impact service availability for a customer.

In one embodiment, the error analysis interface can categorize errors based on the network element responsible for the failure. The error analysis interface can provide an aggregated view of the total error count per network element, offering information into the severity of provisioning failures across different infrastructure components for the wireless telecommunication network. By ranking network elements based on the volume of recorded errors, the network provisioning system 200 and/or engineers can prioritize troubleshooting efforts. Network elements experiencing frequent failures can indicate systemic issues requiring immediate intervention.

The error analysis interface can highlight the dynamic nature of provisioning errors, emphasizing that error volumes fluctuate based on transaction loads, system updates, and network conditions. Observations in production can indicate that error counts correlate with traffic volume, customer support inquiries, scheduled maintenance events, and software deployments. Certain errors, such as those resulting from system outages or misconfigurations, can be mitigated, whereas unavoidable transaction failures will persist due to service constraints. The error data in the error analysis interface can indicate the necessity for automatic and intelligent provisioning error prioritization. While high-frequency errors may not always be the most critical, low-frequency errors affecting high-priority customers can have significant service impacts. The integration of ECAP 500 into network provisioning system 200 can ensure that the error data from the one or more error analysis interface are utilized for real-time anomaly detection, forecasting, and automated corrective actions.

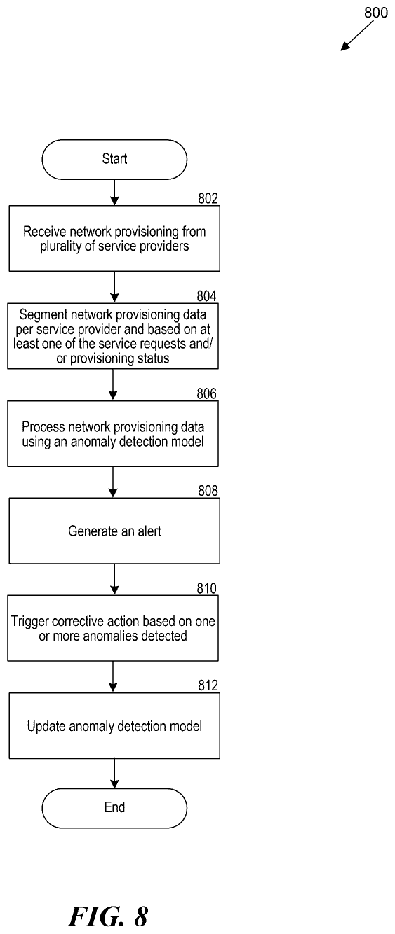

FIG. 8 is a flowchart of a process 800 performed by a network provisioning system for detecting and responding to anomalies in network provisioning for a wireless telecommunications network.

At 802, the network provisioning system receives network provisioning data from a plurality of service providers each supported by a wireless telecommunications network. The network provisioning system is configured to receive extensive network provisioning data from multiple service providers, which can include METRO, Postpaid, Prepaid, and Wholesale. The network provisioning data can consist of service requests for actions such as activating subscriber voicemail, changing plans, and identifying service providers, along with time parameters linked to these service requests. Additionally, the network provisioning data includes provisioning status indicators such as transactions per second values and error codes, which reflect both successful and failed attempts at provisioning.

At 804, the network provisioning system segments the network provisioning data per service provider. The network provisioning system also segments the network provisioning data based on at least one of the service requests and/or provisioning status. The network provisioning system is configured to segment the received data according to the service provider and based on distinct elements like service requests and provisioning status. Each segment of data can incorporate service provider identifiers, timestamps associated with provisioning requests, transactions per second metrics, relevant error codes, and affected network elements. By executing this segmentation, the network provisioning system can improve the anomaly detection model's precision as the segmented data allows the model to discern and analyze trends and deviations distinctly within isolated segments, thereby distinguishing between localized and systemic anomalies.

At 806, the network provisioning system processes the segmented network provisioning data using an anomaly detection model. The anomaly detection model can identify one or more anomalies in provisioning operations by comparing the network provisioning data against expected provisioning patterns. This processing involves detecting from the plurality of service providers, one or more issues for the wireless telecommunications network. The anomaly detection model is a machine learning model trained to use historical provisioning data to define standard provisioning behaviors and expected patterns. For example, by analyzing statistical spikes in transaction per second values, increased failure rates, or unexpected error codes, the anomaly detection model can uncover anomalies indicating provisioning failures and systemic issues across multiple service providers.

At 808, in response to detecting the one or more anomalies, an alert is generated. The alert indicates the type and severity of the one or more anomalies. The alert identifies the affected service providers and the network elements responsible for the anomalies. In some embodiments, the alert is then transmitted to a network operations team for corrective action to restore the affected service providers and network elements. In another embodiment, the alert can trigger an automatic response from the network provisioning system.

At 810, the network provisioning system triggers the corrective action based on the detected anomalies. The corrective action could involve adjusting network provisioning parameters, disabling a failing provisioning cluster to prevent further service degradation, redirecting provisioning requests to an alternative functioning cluster, or deploying a software patch via a CI/CD pipeline to resolve the detected issues.

At 812, the anomaly detection model is continuously updated by integrating real-time network provisioning data, recorded anomalies, and corrective actions into a feedback loop. The continuous updating improves the anomaly detection model's accuracy by adapting to newly detected anomalies and refining future anomaly detection patterns. The network provisioning system is configured to provide ongoing refinement and improvement of the anomaly detection model. By integrating real-time provisioning data, logged anomalies, and corrective actions taken, the network provisioning system forms a feedback loop that can improve the model's precision and responsiveness. This continuous learning mechanism allows the model to adapt to new anomaly types, evolving network conditions, and changes in service provider operations, thereby increasing its accuracy over time.

### Computer System

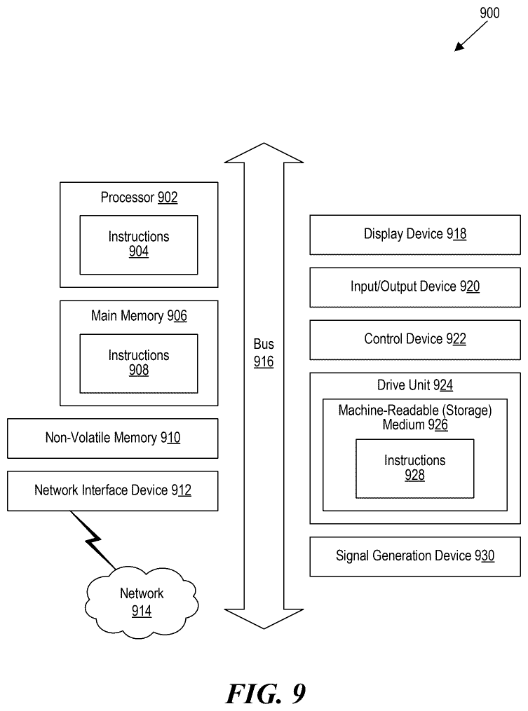

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A method for detecting and responding to anomalies in network provisioning, the method comprising:
receiving, by a network provisioning system, network provisioning data from a plurality of service providers each supported by a wireless telecommunications network,
wherein the network provisioning data includes service requests and/or provisioning status;
segmenting, by the network provisioning system, the network provisioning data per service provider and based on at least one of the service requests and/or provisioning status;
processing, by the network provisioning system, the network provisioning data using an anomaly detection model,
wherein the anomaly detection model identifies one or more anomalies in provisioning operations by comparing the network provisioning data against expected provisioning patterns, and
wherein the anomaly detection model detects from the plurality of service providers one or more issues for the wireless telecommunications network;
in response to detecting the one or more anomalies, generating an alert,
wherein the alert indicates a type and severity of the one or more anomalies,
wherein the alert identifies one or more affected service providers from the plurality of service providers and network elements responsible for the one or more anomalies;
triggering a corrective action based on the one or more anomalies detected,
wherein the corrective action comprises at least one of the following: adjusting network provisioning parameters, disabling a failing provisioning cluster to prevent further service degradation, redirecting provisioning requests to an alternative functioning cluster, or deploying a software patch via a continuous integration/continuous deployment (CI/CD) pipeline to resolve a detected issue;
updating the anomaly detection model continuously by integrating real-time network provisioning data, recorded anomalies, and corrective actions into a feedback loop,
wherein the updated anomaly detection model improves in accuracy by adapting to newly detected anomalies and refining future anomaly detection patterns.

2. The method of claim 1, wherein the provisioning status comprises indicators of successful and failed provisioning attempts, including associated error codes; and
wherein the service requests include at least one of service activations, service modifications, service suspensions, subscriber authentication requests, or service terminations.

3. The method of claim 1, wherein segmenting the network provisioning data further comprises:
categorizing the network provisioning data based on at least one of a time parameter, transaction per second values, associated error codes, or affected network elements.

4. The method of claim 1, wherein the anomaly detection model is a machine learning model trained using historical provisioning status included in the network provisioning data, transaction per second values, and network provisioning system failures to improve anomaly detection accuracy, and wherein the anomaly detection model is configured to perform operations including:
establishing expected provisioning patterns based on the historical provisioning status to differentiate between provisioning failures that occur under normal operating conditions and the one or more anomalies.

5. The method of claim 4, further comprising:
indicating transaction per second values that represent a number of provisioning requests processed by the network provisioning system within a given time parameter.

6. The method of claim 1, further comprising:
establishing the expected provisioning patterns using the network provisioning data, and
wherein the expected provisioning patterns represent a baseline of normal provisioning behavior per service provider, network element, and service request, and wherein the expected provisioning patterns include provisioning success rates, failure rates, transaction per second values, and service provider specific provisioning trends over time.

7. The method of claim 1, further comprising the anomaly detection model to perform operations including:
distinguishing between provisioning failures that occur under normal operating conditions and the one or more anomalies by analyzing statistical deviations from the expected provisioning patterns,
wherein the expected provisioning patterns are established using historical provisioning success rates, failure rates, and service provider-specific transaction patterns, and
wherein the one or more anomalies indicate systemic network issues requiring corrective action.

8. The method of claim 1, wherein generating the alert further comprises prioritizing the alert based on a severity assessment, wherein alerts associated with the one or more anomalies affecting one or more service providers from the plurality of service providers are prioritized for corrective action before alerts associated with other types of severity anomalies.

9. The method of claim 1, wherein triggering the corrective action further comprises rerouting provisioning requests from a failing provisioning cluster to an alternative provisioning cluster in a different data center to mitigate provisioning failures and maintain service continuity in response to detecting the one or more anomalies.

10. The method of claim 1, wherein updating the anomaly detection model further comprises integrating real-time feedback from corrective actions taken in response to the one or more anomalies into the feedback loop to refine the anomaly detection model, thereby improving the accuracy of the anomaly detection model in detecting and predicting future occurrences of the one or more anomalies in network provisioning.

11. A system for detecting and responding to anomalies in network provisioning comprising:
at least one hardware processor; and
at least one non-transitory memory storing instructions, which, when executed by the at least one hardware processor, cause the system to:
receive network provisioning data from a plurality of service providers each supported by a wireless telecommunications network,
wherein the network provisioning data includes service requests and/or provisioning status;
segment the network provisioning data per service provider and based on at least one of the service requests and/or provisioning status;
process by the network provisioning system, the network provisioning data using an anomaly detection model,
wherein the anomaly detection model identifies one or more anomalies in provisioning operations by comparing the network provisioning data against expected provisioning patterns, and
wherein the anomaly detection model detects from the plurality of service providers one or more issues for the wireless telecommunications network;
in response to detecting the one or more anomalies, generate an alert,
wherein the alert indicates a type and severity of the one or more anomalies,
wherein the alert identifies one or more affected service providers from the plurality of service providers and network elements responsible for the one or more anomalies;
trigger a corrective action based on the one or more anomalies detected,
wherein the corrective action comprises at least one of the following:
adjusting network provisioning parameters, disabling a failing provisioning cluster to prevent further service degradation, redirecting provisioning requests to an alternative functioning cluster, or deploying a software patch via a continuous integration/continuous deployment (CI/CD) pipeline to resolve a detected issue;
update the anomaly detection model continuously by integrating real-time network provisioning data, recorded anomalies, and corrective actions into a feedback loop,
wherein the updated anomaly detection model improves in accuracy by adapting to newly detected anomalies and refining future anomaly detection patterns.

12. The system of claim 11, wherein the provisioning status comprises indicators of successful and failed provisioning attempts, including associated error codes; and
wherein the service requests include at least one of service activations, service modifications, service suspensions, subscriber authentication requests, or service terminations.

13. The system of claim 11, wherein the anomaly detection model is a machine learning model trained using historical provisioning status included in the network provisioning data, transaction per second values, and network provisioning system failures to improve anomaly detection accuracy, and wherein the anomaly detection model is configured to perform operations including:
establishing expected provisioning patterns based on the historical provisioning status to differentiate between provisioning failures that occur under normal operating conditions and the one or more anomalies.

14. The system of claim 13, further caused to:
indicate transaction per second values that represent a number of provisioning requests processed by the network provisioning system within a given time parameter.

15. The system of claim 11, further caused to:
establishing the expected provisioning patterns using the network provisioning data, and wherein the expected provisioning patterns represent a baseline of normal provisioning behavior per service provider, network element, and service request, and wherein the expected provisioning patterns include provisioning success rates, failure rates, transaction per second values, and service provider specific provisioning trends over time.

16. A non-transitory, computer-readable storage medium comprising instructions recorded thereon, wherein the instructions, when executed by at least one data processor of a system, cause the system to:
receive network provisioning data from a plurality of service providers each supported by a wireless telecommunications network,
wherein the network provisioning data includes service requests and/or provisioning status;
segment the network provisioning data per service provider and based on at least one of the service requests and/or provisioning status;
process by the network provisioning system, the network provisioning data using an anomaly detection model,
wherein the anomaly detection model identifies one or more anomalies in provisioning operations by comparing the network provisioning data against expected provisioning patterns, and
wherein the anomaly detection model detects from the plurality of service providers one or more issues for the wireless telecommunications network;
in response to detecting the one or more anomalies, generate an alert,
wherein the alert indicates a type and severity of the one or more anomalies,
wherein the alert identifies one or more affected service providers from the plurality of service providers and network elements responsible for the one or more anomalies;
trigger a corrective action based on the one or more anomalies detected,
wherein the corrective action comprises at least one of the following: adjusting network provisioning parameters, disabling a failing provisioning cluster to prevent further service degradation, redirecting provisioning requests to an alternative functioning cluster, or deploying a software patch via a continuous integration/continuous deployment (CI/CD) pipeline to resolve a detected issue;
update the anomaly detection model continuously by integrating real-time network provisioning data, recorded anomalies, and corrective actions into a feedback loop,
wherein the updated anomaly detection model improves in accuracy by adapting to newly detected anomalies and refining future anomaly detection patterns.

17. The non-transitory, computer-readable storage medium of claim 16, wherein the anomaly detection model of the system is further caused to perform operations including:
distinguishing between provisioning failures that occur under normal operating conditions and the one or more anomalies by analyzing statistical deviations from the expected provisioning patterns,
wherein the expected provisioning patterns are established using historical provisioning success rates, failure rates, and service provider-specific transaction patterns, and
wherein the one or more anomalies indicate systemic network issues requiring corrective action.

18. The non-transitory, computer-readable storage medium of claim 16, wherein the system is further caused to:
prioritize the alert based on a severity assessment, wherein alerts associated with the one or more anomalies affecting one or more service providers from the plurality of service providers are prioritized for corrective action before alerts associated with other types of severity anomalies.

19. The non-transitory, computer-readable storage medium of claim 16, wherein the system is further caused to:
reroute provisioning requests from a failing provisioning cluster to an alternative provisioning cluster in a different data center to mitigate provisioning failures and maintain service continuity in response to detecting the one or more anomalies.

20. The non-transitory, computer-readable storage medium of claim 16, wherein the system is further caused to:
update the anomaly detection model by integrating real-time feedback from corrective actions taken in response to the one or more anomalies into the feedback loop to refine the anomaly detection model, thereby improving the accuracy of the anomaly detection model in detecting and predicting future occurrences of the one or more anomalies in network provisioning.
